(19) United States
(12) Patent Application Publication
(10) Pub. No.: US 2025/0052869 A1
(43) Pub. Date: Feb. 13, 2025

(54) FMCW LIGHT DETECTION AND RANGING SYSTEM

(71) Applicant: BEIJING MORELITE SEMICONDUCTOR CO., LTD., Beijing (CN)

(72) Inventors: Yunsong WANG, Beijing (CN); Banghong ZHANG, Beijing (CN); Guomin JIANG, Beijing (CN); Guan WANG, Beijing (CN); Jie SUN, Beijing (CN); Tianbo SUN, Beijing (CN)

(21) Appl. No.: 18/799,605

(22) Filed: Aug. 9, 2024

(30) Foreign Application Priority Data
Aug. 11, 2023 (CN) 202311013358.3

(51) Int. Cl. G01S 7/481; G01S 17/34; G02B 26/12; G02B 27/28

(52) U.S. Cl. CPC G01S 7/4817; G01S 7/4811; G01S 17/34; G02B 26/125; G02B 27/285

(57) ABSTRACT

Provided is an FMCW light detection and ranging (LiDAR) system. The FMCW LiDAR system includes: a laser source, emitting a frequency-swept laser beam; a light engine, comprising an optical transmitter/receiver, where the light engine is configured to receive the frequency-swept laser beam, and transmit, as a detection beam, at least a part of the frequency-swept laser beam from the optical transmitter/receiver, and the optical transmitter/receiver receives a reflected beam formed after the detection beam is incident on an obstacle; a scanning component, on one side of the optical transmitter/receiver and configured to deflect the detection beam to scan the detection beam; and a birefringent component, configured to compensate for a transmission and reception offset angle caused by motion of the scanning component, to enable the detection beam and the reflected beam to be transmitted and received by a same port of the optical transmitter/receiver.

### CROSS-REFERENCE TO RELATED APPLICATION

This application claims a priority from a Chinese Patent Application No. 202311013358.3 filed on Aug. 11, 2023, the disclosures of which are incorporated in their entirety by reference herein.

### TECHNICAL FIELD

The present disclosure relates to the field of light detection and ranging (LiDAR) technologies, in particular to a Frequency Modulated Continuous Wave (FMCW) LiDAR system.

### BACKGROUND

A LIDAR system is a radar system that detects a position, a velocity, and other characteristic parameters of a target by emitting a laser beam. The working principle of the LiDAR system includes: emitting a detection signal to the target, then comparing the received signal reflected back from the target with the emitted signal, and after appropriate processing, obtaining relevant information about the target, such as a distance, an orientation, an altitude, a speed, an attitude, a shape and other parameters of the target, so as to detect, track and identify the target such as an aircraft and a missile. Currently, LiDAR systems are widely deployed in various scenarios, including autonomous vehicles. The LiDAR system can actively estimate a distance to an environmental feature, and a velocity of the environmental feature when scanning a scene, and can generate point position clouds indicating a three-dimensional shape of an environmental scene.

### SUMMARY

Some embodiments of the present disclosure provide a Frequency Modulated Continuous Wave (FMCW) LiDAR system, which includes:
a laser source, configured to emit a frequency-swept laser beam;
a light engine, including an optical transmitter/receiver, where the light engine is configured to receive the frequency-swept laser beam, and transmit, as a detection beam, at least a part of the frequency-swept laser beam from the optical transmitter/receiver, and the optical transmitter/receiver is further configured to receive a reflected beam formed after the detection beam is incident on an obstacle;
a scanning component, arranged on one side of the optical transmitter/receiver and configured to deflect the detection beam to perform scanning on the detection beam; and
a birefringent component, configured to compensate for a transmission and reception offset angle caused by motion of the scanning component, to enable the detection beam and the reflected beam to be transmitted and received by a same port of the optical transmitter/receiver.

In some embodiments, the FMCW LiDAR system further includes: a lens component, arranged between the optical transmitter/receiver and the scanning component, configured to collimate the detection beam and couple the reflected beam into the optical transmitter/receiver, where the detection beam is a beam in a first polarization mode with a first polarization direction, the reflected beam is a beam in a second polarization mode with a second polarization direction, the first polarization direction is perpendicular to the second polarization direction, and the beam in the first polarization mode and the beam in the second polarization mode have different refractive indices in the birefringent component.

In some embodiments, the birefringent component is configured with a compensation offset angle α for the reflected beam, and the compensation offset angle α is determined by the following formula:

$$0 < α \leq θ m$$

where θₘ is a maximum value of the transmission and reception offset angle, and θₘ is determined by the following formula:

$${θ}_{m} = ω \times Δ t = ω \times \frac{2 {L}_{m}}{c}$$

where ω is a scanning angular velocity of the scanning component, Lₘ is a maximum detection distance of the FMCW LiDAR system, and c is the speed of light.

In some embodiments, the birefringent component includes an optical wedge, the optical wedge is located between the lens component and the scanning component, an inclined surface of the optical wedge is farther from the lens component than a plane surface of the optical wedge, an optical axis of the optical wedge is perpendicular to an optical axis of the lens component, and the compensation offset angle α satisfies the following formula:

$$α = arctan ( {n}_{2} sin β ) - arctan ( {n}_{1} sin β )$$

where n₁ is a refractive index of the beam in the first polarization mode in the optical wedge, n₂ is a refractive index of the beam in the second polarization mode in the optical wedge, and β is a wedge angle of the optical wedge.

In some embodiments, the birefringent component includes a polarization beam-splitter prism group, the polarization beam-splitter prism group is arranged between the lens component and the scanning component, the polarization beam-splitter prism group includes a first right-angle prism and a second right-angle prism having inclined surfaces bonded together, an optical axis of the first right-angle prism is parallel to an optical axis of the lens component, the second right-angle prism is arranged on a side of the first right-angle prism away from the lens component, an optical axis of the second right-angle prism is perpendicular to the optical axis of the lens component, and the compensation offset angle α satisfies the following formula:

$$α = arctan ( 0.7 {n}_{4} ) - arc ta n ( 0.7 {n}_{3} )$$

where n₃ is a refractive index of the beam in the first polarization mode in the polarization beam-splitter prism group, and n₄ is a refractive index of the beam in the second polarization mode in the polarization beam-splitter prism group.

In some embodiments, the birefringent component includes a birefringent flat lens, the birefringent flat lens is arranged between the lens component and the optical transmitter/receiver, the birefringent flat lens is arranged parallel to the lens component, an optical axis of the birefringent flat lens intersects with an optical axis of the lens component, and the compensation offset angle α satisfies the following formula:

$$α = arctan ( \frac{d}{f} )$$

$$d = D \cdot ( 1 - \frac{{n}_{5}^{2}}{{n}_{6}^{2}} ) \cdot \frac{tan ( γ )}{1 + \frac{{n}_{5}^{2}}{{n}_{6}^{2}} \cdot {tan}^{2} ( γ )}$$

where n₃ is a refractive index of the beam in the first polarization mode in the birefringent plate lens, n₆ is the refractive index of the beam in the second polarization mode in the birefringent plate lens, γ is an angle between the optical axis and a plane surface of the birefringent plate lens, d is a thickness of the birefringent plate lens, and f is a focal length of the lens component.

In some embodiments, the light engine includes a LiDAR chip, and the LiDAR chip includes:
a frequency-swept laser beam receiving port, configured to receive the frequency-swept laser beam;
a beam splitter, connected to the frequency-swept laser beam receiving port, and configured to split the frequency-swept laser beam into the detection beam and a local oscillator beam;
a mixer, configured to receive the local oscillator beam and the reflected beam, and mix the local oscillator beam and the reflected beam to obtain a frequency-mixed laser; and
a balanced detector, configured to receive the frequency-mixed laser and output a detection electrical signal based on the frequency-mixed laser,
the FMCW LiDAR system further includes: an obtaining and processing device, electrically connected to the balance detector, and configured to receive the detection electrical signal from the balance detector, and process the detection electrical signal to determine a distance of the obstacle relative to the FMCW LiDAR system and/or a velocity of the obstacle.

In some embodiments, the LiDAR chip further includes: a polarization splitter-rotator, used as the optical transmitter/receiver, and configured to receive the detection beam and transmit the detection beam, receive the reflected beam and change a polarization direction of the reflected beam, the mixer is configured to receive the local oscillator beam from the beam splitter and the reflected beam from the polarization splitter-rotator.

In some embodiments, the LiDAR chip further includes:
a detection beam transmitting port, configured to receive the detection beam from the beam splitter and transmit the detection beam; and
a reflected beam receiving port, configured to receive the reflected beam,
the optical transmitter/receiver includes a circulator, the circulator includes a first port, a second port, and a third port, where the first port is connected to the detection beam transmitting port, and is configured to receive the detection beam transmitted by the detection beam transmitting port, and transmit the detection beam to the second port, where the detection beam is transmitted out from the second port, the second port is further configured to receive the reflected beam and transmit the reflected beam to the third port, and the third port is connected to the reflected beam receiving port, and is configured to transmit the reflected beam to the reflected beam receiving port.

Some embodiments of the present disclosure provide a mobile device including an FMCW LiDAR system as described in the aforementioned embodiments.

Compared with the related technologies, the above scheme of the embodiments of the present disclosure has at least the following beneficial effects.

The FMCW (Frequency-Modulated Continuous Wave) LiDAR system in the present disclosure can compensate for a transmission and reception offset angle caused by rotation of a scanning component by adding a birefringent component. In such way, a detection beam and a reflected beam in each channel of the FMCW LiDAR system can be transmitted and received through a same port, thereby ensuring detection performance of the FMCW LiDAR system while minimizing the size of the FMCW LiDAR system.

### BRIEF DESCRIPTION OF THE DRAWINGS

The accompanying drawings are incorporated into the specification and form a part of the specification, illustrates embodiments in accordance with the present disclosure, and are used together with the specification to explain principles of the present disclosure. It is obvious that the drawings described below are only some embodiments of the present disclosure, and based on these drawings, person of ordinary skill in the art can obtain other drawings without creative effort.

FIG. 1 is a schematic structural diagram of an FMCW LiDAR system provided in some embodiments of the present disclosure;

FIG. 2 is a schematic diagram of a transmission and reception offset angle caused by movement of a scanning component in FIG. 1;

FIG. 3 is a curve graph showing a relationship between an intensity of a reflected beam of an FMCW LiDAR system and a distance to an obstacle.

FIG. 4 is a curve graph showing a relationship between a coupling efficiency of the reflected beam and a transmission and reception offset angle or the distance to the obstacle;

FIG. 5 is a schematic diagram of an optical path at a lens component and a birefringent component in FIG. 1;

FIG. 6 is a schematic structural diagram of an FMCW LiDAR system provided in some embodiments of the present disclosure;

FIG. 7 is a schematic diagram of an optical path at a lens component and a polarization beam-splitter prism group in FIG. 6;

FIG. 8 is a schematic structural diagram of an FMCW LiDAR system provided in some embodiments of the present disclosure;

FIG. 9 is a schematic diagram of an optical path at a lens component and a birefringent flat lens in FIG. 8;

FIG. 10 is a schematic structural diagram of an optical engine provided in some embodiments of the present disclosure; and

FIG. 11 is a schematic structural diagram of an optical engine provided in some embodiments of the present disclosure.

### DETAILED DESCRIPTION

In order to clarify the objective, technical solutions, and advantages of the present disclosure, a detailed description of the present disclosure will be further provided below in conjunction with the accompanying drawings. Obviously, the described embodiments merely relate to a part of, rather than all of the embodiments of the present disclosure, and based on these embodiments of the present disclosure, a person of ordinary skill in the art may obtain other embodiments without creative effort, which shall fall within the scope of the present disclosure.

Terms used in the embodiments of the present disclosure are only for the purpose of describing specific embodiments and are not intended to limit the present disclosure. The singular forms of “one”, “the” and “this” used in the embodiments of the present disclosure and the appended claims are also intended to include the plural form, unless the context clearly represents other meaning, and “plurality” generally includes at least two.

It should be appreciated that the term “and/or” used in this specification is just used to describe an association relationship between associated objects and indicates that there may be three types of relationships. For example, A and/or B may represent three situations including: A alone, both A and B, and B alone. In addition, the character “/” in this specification generally indicates that associated objects before and after the character are in an “or” relationship.

It should be appreciated that although terms such as first, second and third may be used for description in embodiments of the present disclosure, and should not be limited thereto. These terms are only used for distinguishing. For example, without departing from the scope of the embodiments of the present disclosure, the first may also be referred to as the second, and similarly, the second may also be referred to as the first.

It should be further noted that terms such as “including” and “having” and any variations thereof are intended to cover non-exclusive inclusion. Thus, a commodity or a device that includes a series of elements not only includes those elements, but also includes other elements not explicitly listed, or elements inherent to such commodity or device. For an element limited by a statement “including a” without further limitations, other identical elements may not excluded from the commodity or the device that includes this element.

In related technologies, existing distance measurement methods of the LiDAR system mainly include the following two technical routes: time of flight (Time of Flight, ToF) and frequency-modulated continuous wave (Frequency-Modulated Continuous Wave, FMCW).

The distance measurement principle of ToF includes calculating a distance by multiplying a flight time of a light pulse between a target object and the LiDAR system by the speed of light, where the pulse amplitude modulation technology is adopted in a ToF LiDAR system. Unlike the ToF route, FMCW mainly includes transmitting and receiving continuous laser beams, interfering with the return light and the local light, measuring a frequency difference between transmission and reception by using a heterodyne detection technology, and then converting a distance of the target object based on the frequency difference. In short, ToF uses the time to measure a distance, while FMCW uses the frequency to measure a distance.

FMCW has the following advantages compared to ToF. Light waves of ToF are easily interfered by environmental light, while light waves of FMCW have strong anti-interference ability. The signal-to-noise ratio of ToF is relatively low, while the signal-to-noise ratio of FMCW is relatively high. The data of ToF in the dimension of velocity has a low quality, while FMCW can obtain data for each pixel in the dimension of velocity.

The LiDAR system using the FMCW technology has good technical advantages, but there are the following problems in practical applications:

For the conventional FMCW LiDAR system, in order to reduce the size of the FMCW LiDAR system, each detection channel is usually used with a corresponding optical transmitter/receiver. A detection beam and a reflected beam in each detection channel are transmitted and received through a same port of an optical transmitter/receiver corresponding to the detection channel, and the detection beam is collimated, and the detection beam and the reflected beam are coupled by a lens to the same port, which is also referred to as transceiver port. A detection channel where the transceiver port is located has an instantaneous field of view (iFOV), which is calculated by the formula

$$iFOV \approx \frac{MVD}{F} ,$$

where MFD is a mode field diameter of the transceiver port, and F is an effective focal length of the lens. A range of angles at which the beam can be transmitted/received in the same port at a certain moment depends on the size of the instantaneous field of view.

Usually, a scanning component such as a rotating mirror is used in a conventional FMCW LiDAR system to scan a detection beam. In order to satisfy the frame rate requirement of a LiDAR point cloud, it is necessary to ensure that the rotating mirror reaches a certain rotational angular velocity. It is considered that during the distance measurement process, the beam may fly in the air for a period of time, which includes a time for the detection beam to propagate to an obstacle, and a time for a reflected beam to return from the obstacle. During this period, the scanning component does not stop rotating, which is equivalent to a certain deviation in pointing angles of transmission and reception at the transceiver port mentioned above, that is, a deviation between a pointing angle of the detection beam and a pointing angle of the received beam is referred to as a transmission and reception offset angle. The transmission and reception offset angle may be described by a formula θ=ω*Δt. When θ=0, optical axes of the detection beam and the reflected beam completely coincide, and the detection capability of the FMCW LiDAR system is the strongest. When 0<θ≤iFOV, the detection capability of the FMCW LiDAR system may decrease correspondingly. When Δθ>iFOV, the transceiver port may be unable to detect the reflected beam.

The present disclosure provides an FMCW LiDAR system, which includes: a laser source, configured to emit a frequency-swept laser beam; a light engine, including an optical transmitter/receiver, where the light engine is configured to receive the frequency-swept laser beam and transmit, as a detection beam, at least a part of the frequency-swept laser beam from the optical transmitter/receiver, and the optical transmitter/receiver is further configured to receive a reflected beam formed after the detection beam is incident on an obstacle; a scanning component, arranged on one side of the optical transmitter/receiver and configured to deflect the detection beam to achieve scanning of the detection beam; and a birefringent component, configured to compensate for a transmission and reception offset angle caused by motion of the scanning component, to enable the detection beam and the reflected beam to be transmitted and received by a same port of the optical transmitter/receiver.

The FMCW LiDAR system in the present disclosure can compensate for a transmission and reception offset angle caused by rotation of a scanning component by adding a birefringent component. In such way, the reflected beam in each channel of the FMCW LiDAR system can be maximally received by a same optical transmitter/receiver that transmits the corresponding detection beam, and the detection beam and the reflected beam can be transmitted and received through a same port, thereby ensuring detection performance of the FMCW LiDAR system while minimizing the size of the FMCW LiDAR system.

Optional embodiments of the present disclosure will be described below in conjunction with the accompanying drawings.

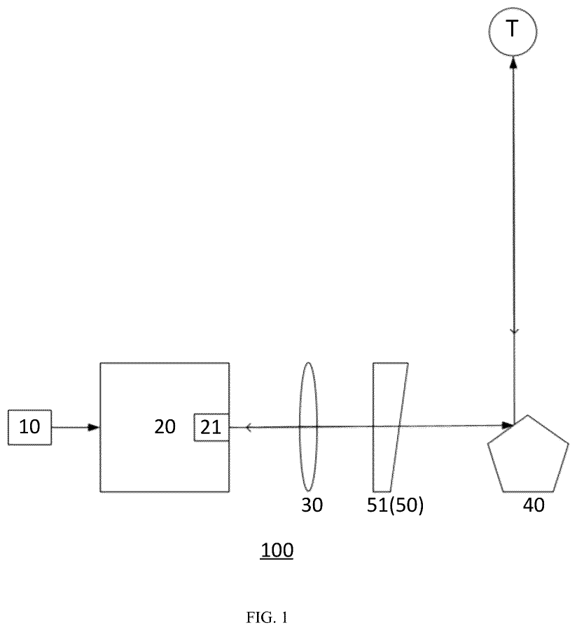

FIG. 1 is a schematic structural diagram of an FMCW LiDAR system according to some embodiments of the present disclosure. As shown in FIG. 1, an FMCW LiDAR system 100 according to the present disclosure includes a laser source 10, an optical engine 20, a lens component 30, a scanning component 40, and a birefringent component 50.

The laser source 10 is configured to emit a frequency-swept laser beam, and a frequency of the frequency-swept laser beam varies over time, such as a periodic triangular wave. The laser source 10 may be directly modulated by an electrical signal. That is to say, the electrical signal driving the laser source 10 may vary over time, may make the laser source 10 generate and output a frequency-swept laser beam, that is, a beam of light with a frequency that varies within a predetermined range. In some embodiments, the laser source 10 may also use a modulator to modulate the frequency of the outputted laser having a constant frequency, achieving the output of the frequency-swept laser beam. Specifically, the frequency of the laser beam output by the laser source 10 is basically constant, which is referred to as a frequency of an unmodulated beam, for example, 100 THz to 300 THz. The modulator receives the laser beam having a basically constant frequency and receives a modulation signal. Under the action of the modulation signal, and the modulator modulates the laser beam having a basically constant frequency into a swept frequency beam with a frequency that changes over time and outputs it.

The light engine 20 includes an optical transmitter/receiver 21. The optical transmitter/receiver 21 is configured to receive the frequency-swept laser beam emitted by the laser source 10 and transmit, as a detection beam, at least a part of the frequency-swept laser beam from the optical transmitter/receiver 21. The optical transmitter/receiver is further configured to receive a reflected beam generated after the detection beam is incident on an obstacle T. The FMCW LiDAR system 100 measures a distance and/or a velocity of a test point on the obstacle based on the reflected beam, which may be understood as a distance between the test point on the obstacle and the FMCW LiDAR system 100.

The lens component 30 is arranged on one side of the optical transmitter/receiver 21, configured to collimate the detection beam and couple the reflected beam into the optical transmitter/receiver 21. The lens component 30 may be a lens or a lens group with focusing and collimation functions. Specifically, the lens component 30 collimates the detection beam emitted by the optical transmitter/receiver 21 to ensure its propagation distance. After the detection beam reaches the obstacle, a reflected beam is generated. The reflected beam is focused and coupled into the optical transmitter/receiver 21 through the lens component 30 to facilitate the subsequent detection of the FMCW LiDAR system.

The scanning component 40 is arranged on a side of the lens component 30 away from the optical transmitter/receiver 21, configured to deflect the detection beam incident on the lens component to achieve scanning of the detection beam. The scanning component 40, such as a rotating mirror, a rotating prism, a rotating wedge, a vibrating mirror, MEMS, etc., can scan the detection beam incident on the lens component through its own regular motion. Therefore, a line LiDAR system may be used for surface detection. Furthermore, test information of each test point on the surface of the obstacle is obtained to form a laser point cloud, thereby determining a three-dimensional structure of the obstacle T. Taking the rotating mirror as an example, the rotating mirror needs to rotate within a predetermined angle range at a predetermined rotational angular velocity, to deflect the detection beam incident on the lens component 30 and to achieve scanning of the detection beam.

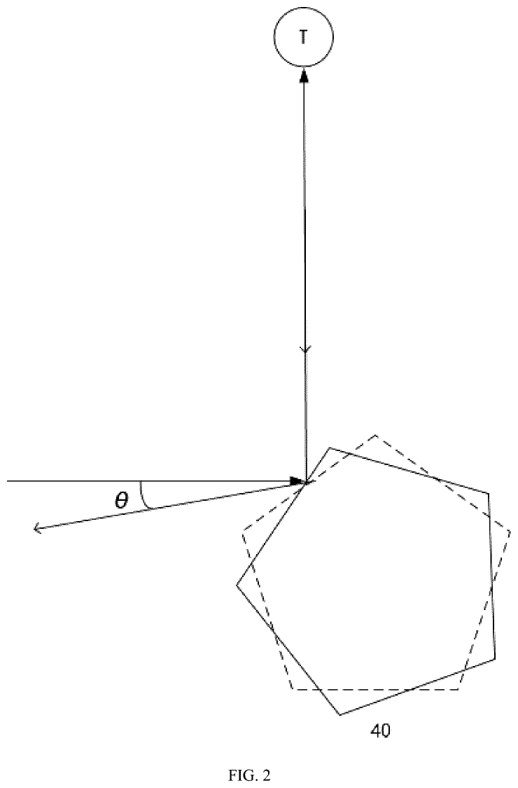

FIG. 2 is a schematic diagram of a transmission and reception offset angle caused by the scanning component in FIG. 1 during its motion. As shown in FIG. 2, when the scanning component 40 is in a state indicated by the dashed line, a detection beam is incident on the scanning component 40 and reflected to the obstacle T. After reaching the obstacle, the detection beam is reflected to form a reflected beam. When the reflected beam returns to the scanning component 40, the scanning component 40 is in a state indicated by the solid line due to its motion, and has a predetermined angle deviation relative to the state indicated by the dashed line. There is a deviation between a path of the reflected beam after being reflected by the scanning component 40 and a path of the detection beam, that is, the transmission and reception offset angle θ.

The birefringent component 50 is arranged at a predetermined distance from the lens component 30, and configured to compensate for the transmission and reception offset angle θ caused by the movement of the scanning component 40. In such manner, the reflected beam can be maximally received by the same optical transmitter/receiver that transmits the corresponding detection beam, and the detection beam and the reflected beam are transmitted and received through the same port of the optical transmitter/receiver. The compensated transmission and reception offset angle is smaller than an instantaneous field of view angle (iFOV) of the same port of the optical transmitter/receiver, and as close to 0 as possible. Optical axes of the detection beam and the reflected beam transmitted and received by the same port of the optical transmitter/receiver coincide as much as possible, to ensure the detection capability of the FMCW LiDAR system.

The FMCW LiDAR system of the present disclosure can compensate for the transmission and reception offset angle caused by the rotation of the scanning component by adding a birefringent component, so that a detection beam and a reflected beam in each channel of the FMCW LiDAR system can be transmitted and received through a same port, that is, the transceiver port, thereby ensuring detection performance of the FMCW LiDAR system while minimizing the size of the FMCW LiDAR system.

In some embodiments, the detection beam is a beam in a first polarization mode with a first polarization direction, the reflected beam is a beam in a second polarization mode with a second polarization direction, the first polarization direction is perpendicular to the second polarization direction, and the beam in the first polarization mode and the beam in the second polarization mode have different refractive indices in the birefringent component 50. In this way, the beam in the first polarization mode as the detection beam and the beam in the second polarization mode as the reflected beam have different transmission paths in the birefringent component 50. By utilizing the above properties, it is able to compensate the transmission and reception offset angle caused by the rotation of the scanning component, so that the reflected beam in each channel of the FMCW LiDAR system can be maximally received by a same optical transmitter/receiver that transmits the corresponding detection beam, and the detection beam and the reflected beam can be transmitted and received through a same port. In some embodiments, the beam in the first polarization mode is, for example, a polarized beam in TE mode, and the beam in the second polarization mode is, for example, a polarized beam in TM mode. The detection beam is a polarized beam in TE mode, which is output from the optical transmitter/receiver 21 of the light engine 20, passes through the lens component 30, the birefringent component 50, and the scanning component 40, and then enters the obstacle T. The polarized beam in TE mode reflected by the obstacle T includes both a polarized beam in TE mode and a polarized beam in TM mode. In some embodiments, only the polarized beam in TM mode is used as the reflected beam for detection.

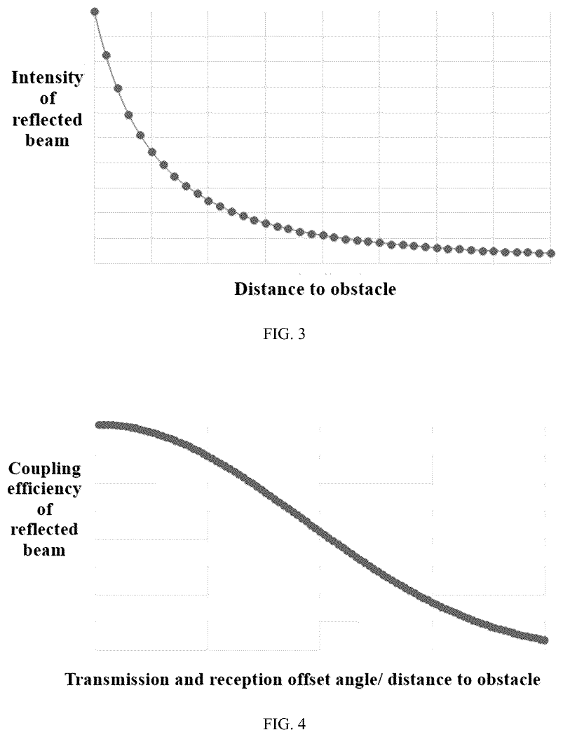

FIG. 3 is a curve graph showing a relationship between an intensity of a reflected beam of an FMCW LiDAR system and a distance to an obstacle. In an FMCW LiDAR system detection scenario, the intensity of the reflected beam is positively correlated with the intensity of the frequency-swept laser beam emitted by a laser source, where the higher the intensity of the reflected beam is, the stronger the detection capability of the FMCW LiDAR system is. As shown in FIG. 3, under other conditions (including the intensity of the scanning laser, the optical components of the FMCW LiDAR system, and relative positions thereof) being invariant, the intensity of the reflected beam, that is, the intensity of the diffuse reflection light, decreases as the distance to the obstacle increases, and there is a quadratic decay relationship between them. In this application, the distance to the obstacle refers to a distance between the LiDAR system and the obstacle.

FIG. 4 is a curve graph showing a relationship between a coupling efficiency of the reflected beam and a transmission and reception offset angle or the distance to the obstacle. The vertical axis represents the coupling efficiency of the reflected beam, and the horizontal axis represents the transmission and reception offset angle or the distance to the obstacle. The transmission and reception offset angle is proportional to the distance to the obstacle. In a case that an optical fiber/waveguide device is used as the optical transmitter/receiver, and used in combination with the lens component, it is necessary to consider the coupling efficiency of the reflected beam coupled into the optical transmitter/receiver under the action of the lens component. According to the theory of fiber optic coupling, the coupling efficiency depends on a degree of matching between a mode field of a spot converged by the lens and a mode field of a fiber. When there is a transmission and reception offset angle, that is, a deviation angle between the light transmission axis and the light reception axis, a spot position of the reflected beam converged by the lens component is correspondingly displaced from the center position of the optical fiber, which results in a Gaussian distribution of the coupling efficiency of the reflected beam with the variation of the transmission and reception offset angle. The transmission and reception offset angle is directly proportional to the flight time of the beam, that is, directly proportional to the distance to the obstacle.

When the FMCW LiDAR system operates, the energy of the reflected beam received by the optical transmitter/receiver is the product of parameters in the two curves in FIG. 3 and FIG. 4.

In some embodiments, the birefringent component is configured with a compensation offset angle α for the reflected beam, which is determined by the following formula:

$$0 < α \leq θ m \qquad equation ( 1 )$$

where θₘ is a maximum value of the transmission and reception offset angle, and θₘ is determined by the following formula:

$${θ}_{m} = ω \times Δ t = ω \times \frac{2 {L}_{m}}{c} \qquad equation ( 2 )$$

where ω is a scanning angular velocity of the scanning component, Δt is the flight time of a beam between the FMCW LiDAR system and the obstacle, Lₘ is a maximum detection distance of the FMCW LiDAR system, which is preset when the FMCW LiDAR system is designed, and c is the speed of light.

In the embodiments, the FMCW LiDAR system can compensate the transmission and reception offset angle caused by the rotation of the scanning component by adding a birefringent component 50, so that the reflected beam in each channel of the FMCW LiDAR system can be maximally received by a same optical transmitter/receiver that transmits the corresponding detection beam, and the detection beam and the reflected beam can be transmitted and received through a same port. For example, in a case that the compensation offset angle α is equal to the maximum value θₘ of the transmission and reception offset angle, when detecting an obstacle at the farthest detection distance Lₘ, the reflected beam can be maximally received by a same optical transmitter/receiver that transmits the corresponding detection beam, and the detection beam and the reflected beam can be transmitted and received through a same port, thereby ensuring the coupling efficiency of the reflected beam, while minimizing the size of the FMCW LiDAR system.

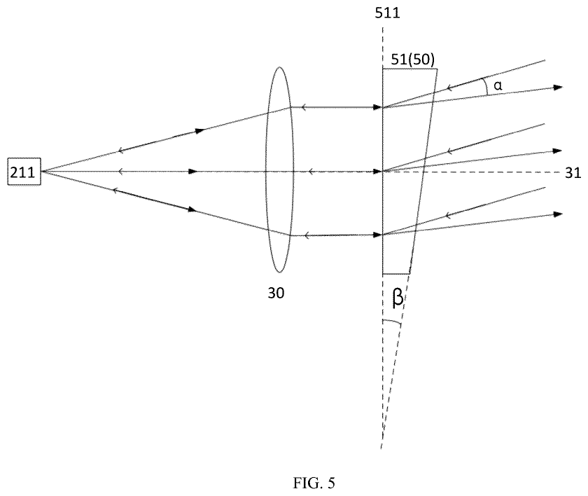

FIG. 5 is a schematic diagram of an optical path at the lens component and the birefringent component in FIG. 1. As shown in FIG. 1 and FIG. 5, the birefringent component 50 includes an optical wedge 51, the optical wedge is located on a side of the lens component away from the optical transmitter/receiver 21. An inclined surface of the optical wedge 51 is farther from the lens component 30 than a plane surface of the optical wedge 51, and the optical axis 511 of the optical wedge 51 is perpendicular to the optical axis of the lens component 30. The detection beam transmitted by a transceiver port 211 of the optical transmitter/receiver 21 towards the lens component 30, for example, is a beam in a first polarization mode. Specifically, the detection beam is a polarized beam in TE mode, and has a certain divergence angle, represented by three light rays (represented by lines with solid arrows). The lens component 30 performs collimation operation on the detection beam, so that the detection beam after passing through the lens component 30 becomes a parallel beam. After passing through the optical wedge 51, the detection beam is deflected by the rotating component 40, and encounters an obstacle, resulting in a reflected beam, such as a beam in a second polarized mode, specifically a polarized beam in TM mode. The reflected beam is also represented by three light rays (indicated by lines with arrows). Due to the movement of the scanning component, such as the rotation of the rotating mirror, the reflected beam does not return along a transmission path of the detection beam, but has a certain transmission and reception offset angle. By utilizing the characteristics of the optical wedge 51, the transmission and reception offset angle can be compensated. FIG. 5 shows an example of the optical wedge 51 fully compensating for the transmission and reception offset angle. In this case, the compensation offset angle α is equal to the transmission and reception offset angle. After compensation by the optical wedge 51, a return path of the reflected beam is the same as the transmission path of the detection beam. The reflected beam is coupled into the transceiver port 211 of the optical transmitter/receiver 21 through the lens component 30, which achieving coaxial transmission and reception of the detection beam and the reflected beam, so as to ensure the coupling efficiency of the reflected beam, and improve the detection performance of the FMCW LiDAR system.

The compensation offset angle α satisfies the following formula:

$$α = arctan ( {n}_{2} sin β ) - arcta n ( {n}_{1} sin β ) \qquad equation ( 3 )$$

where n₁ is the refractive index of the beam in the first polarization mode in the optical wedge, such as the polarized beam in TE mode, n₂ is the refractive index of the beam in the second polarization mode in the optical wedge, such as the polarized beam in TM mode, and β is the wedge angle of the optical wedge.

As mentioned above, the compensation offset angle α may be determined by the maximum value θₘ of the transmission and reception offset angle to be compensated. The maximum value θₘ is related to the scanning angular velocity ω of the scanning component in the FMCW LiDAR system and the farthest detection distance Lₘ of the FMCW LiDAR system. After the compensation offset angle α is determined, the specification of the optical wedge 51 may be selected and determined according to equation (3).

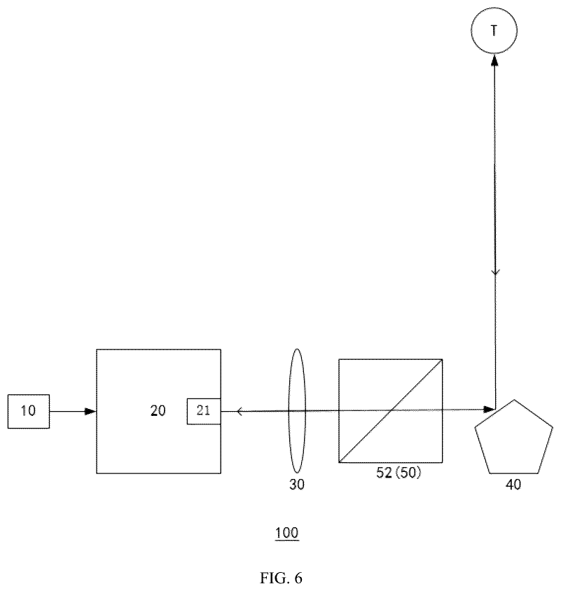

FIG. 6 is a schematic structural diagram of an FMCW LiDAR system provided in some embodiments of the present disclosure. The FMCW LiDAR system in the embodiment shown in FIG. 6 has a similar structure to the FMCW LiDAR system in the embodiment shown in FIG. 1, and the similarities between them are not repeated here. The following mainly describes differences between them.

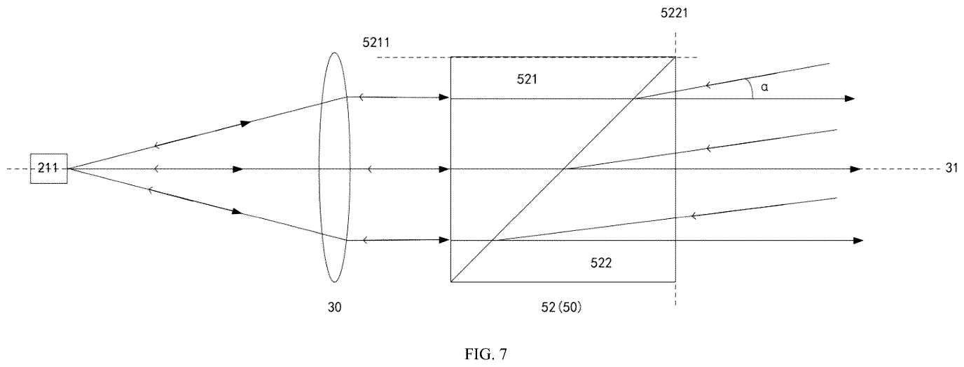

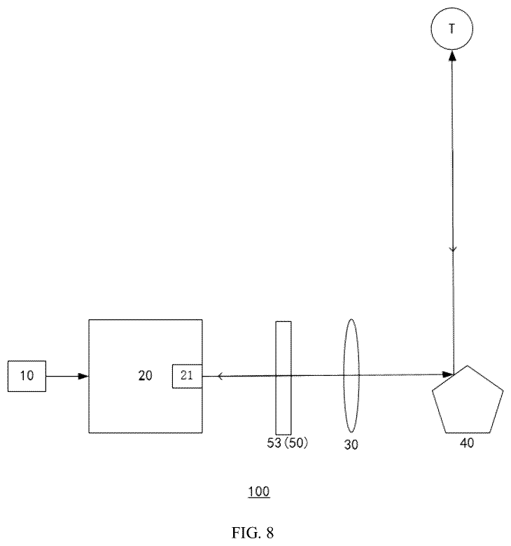

In the FMCW LiDAR system 100 shown in FIG. 6, the birefringent component 50 does not include the optical wedge 51, but includes a polarization beam-splitter prism group 52. FIG. 7 is a schematic diagram of an optical path at the lens component and the polarization beam-splitter prism group in FIG. 6. As shown in FIG. 6 and FIG. 7, the birefringent component 50 includes the polarization beam-splitter prism group 52, which is located on a side of the lens component away from the optical transmitter/receiver 21. The polarization beam-splitter prism group 52 includes a first right-angle prism 521 and a second right-angle prism 522 are bonded together at oblique surfaces of two prisms. A right-angle plane of the first right-angle prism 521 faces the lens component 30, and the optical axis 5211 of the first right-angle prism 521 is parallel to the optical axis 31 of the lens component 30. The second right-angle prism 522 is disposed on a side of the first right-angle prism 521 away from the lens component, and the optical axis 5221 of the second right-angle prism 522 is perpendicular to the optical axis 31 of the lens component 30.

The detection beam emitted from the transceiver port 211 of the optical transmitter/receiver 21 towards the lens component 30, for example, is a beam in a first polarization mode, specifically a polarized beam in TE mode, with a certain divergence angle, represented by three light rays (represented by lines with solid arrows). The lens component 30 performs collimation operation on the detection beam, so that the detection beam after passing through the lens component 30 becomes a parallel beam. After passing through the polarization beam-splitter prism group 52, the detection beam is deflected by the rotating component 40 and encounters an obstacle, resulting in a reflected beam, such as a beam in a second polarization mode, which may be specifically a polarized beam in TM mode. The reflected beam is also represented by three light rays (indicated by lines with arrows). Due to the movement of the scanning component, such as the rotation of the rotating mirror, the reflected beam does not return along a transmission path of the detection beam, but has a certain transmission and reception offset angle. By utilizing the characteristics of the polarization beam-splitter prism group 52, the transmission and reception offset angle can be compensated. FIG. 7 shows an example where the polarization beam-splitter prism group 52 fully compensates for the transmission and reception offset angle. In this case, the compensation offset angle α is equal to the transmission and reception offset angle. After compensation by the polarization beam-splitter prism group 52, a return path of the reflected beam is the same as the transmission path of the detection beam. The reflected beam is coupled into the transceiver port 211 of the optical transmitter/receiver 21 through the lens component 30, which achieves coaxial transmission and reception of the detection beam and the reflected beam, so as to ensure the coupling efficiency of the reflected beam, and improve the detection performance of the FMCW LiDAR system.

The compensation offset angle α satisfies the following formula:

$$α = arctan ( 0.7 {n}_{4} ) - arcta n ( 0.7 {n}_{3} ) \qquad equation ( 4 )$$

where n₃ is the refractive index of the beam in the first polarization mode in the polarization beam-splitter prism group, such as a polarized beam in TE mode, and n₄ is the refractive index of the beam in the second polarization mode in the polarization beam-splitter prism group, such as the polarized beam in TM mode.

As mentioned above, the compensation offset angle α may be determined by the maximum value θₘ of the transmission and reception offset angle to be compensated. The maximum value θₘ is related to the scanning angular velocity ω of the scanning component in the FMCW LiDAR system and the farthest detection distance Lₘ of the FMCW LiDAR system. After the compensation offset angle α is determined, the specification of the optical wedge 51 may be selected and determined according to equation (4).

FIG. 8 is a schematic structural diagram of an FMCW LiDAR system provided in some embodiments of the present disclosure. The FMCW LiDAR system in the embodiment shown in FIG. 8 has a similar structure to the FMCW LiDAR system in the embodiment shown in FIG. 1, and the similarities between them are not repeated here. The following mainly describes the differences between them.

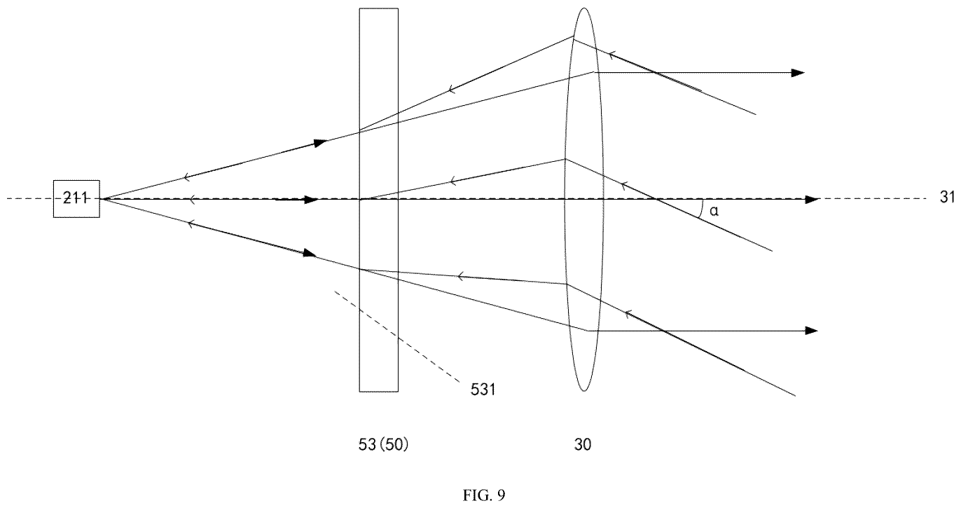

In the FMCW LiDAR system 100 shown in FIG. 8, the birefringent component 50 is arranged between the lens component 30 and the optical transmitter/receiver 21, and does not include the optical wedge 51, but includes a birefringent flat lens 53. FIG. 9 is a schematic diagram of an optical path at the lens component and the birefringent flat lens in FIG. 8. As shown in FIG. 8 and FIG. 9, the birefringent flat lens 53 is arranged between the lens component 30 and the optical transmitter/receiver 21. The birefringent flat lens 53 is arranged parallel to the lens component 30, and the optical axis of the birefringent flat lens 30 intersects with the optical axis of the lens component 30.

The detection beam transmitted from the transceiver port 211 of the optical transmitter/receiver 21 towards the polarization beam-splitter prism group 52, for example, is a first polarization mode beam, specifically a polarized beam in TE mode, with a certain divergence angle, represented by three light rays (represented by lines with solid arrows). The detection beam after passing through the birefringent flat lens 53 is collimated by the lens component 30, so that the detection beam passing through the lens component 30 becomes a parallel beam. After the detection beam is deflected by the rotating component 40 and encounters an obstacle, a reflected beam is formed, such as a beam in a second polarization mode, which may be specifically a polarized beam in TM mode. The reflected beam is also represented by three rays (indicated by lines with arrows). Due to the movement of the scanning component, such as the rotation of the rotating mirror, the reflected beam does not return along a transmission path of the detection beam, but has a certain transmission and reception offset angle. By utilizing the characteristics of the birefringent flat lens 53, the transmission and reception offset angle may be compensated for. An example of the birefringent flat lens 53 fully compensating for the transmission and reception offset angle is shown in FIG. 9. In this case, the compensation offset angle α is equal to the transmission and reception offset angle. After compensation by the birefringent flat lens 53, a return path of the reflected beam is the same as the transmission path of the detection beam. The reflected beam may be coupled into the transceiver port 211 of the optical transmitter/receiver 21, which achieves coaxial transmission and reception of the detection beam and the reflected beam, thereby ensuring the coupling efficiency of the reflected beam, and improving the detection performance of the FMCW LiDAR system.

The compensation offset angle α satisfies the following formula:

$$α = arctan ( \frac{d}{f} ) \qquad equation ( 5 )$$

$$d = D \cdot ( 1 - \frac{{n}_{5}^{2}}{{n}_{6}^{2}} ) \cdot \frac{tan ( γ )}{1 + \frac{{n}_{5}^{2}}{{n}_{6}^{2}} \cdot {tan}^{2} ( γ )} \qquad equation ( 6 )$$

where n₃ is the refractive index of the beam in the first polarization mode in the birefringent plate lens, such as a polarized beam in TE mode, n₃ is the refractive index of the beam in the second polarization mode in the birefringent plate lens, such as a polarized beam in TM mode, γ is an angle between the optical axis and a plane of the birefringent plate lens, d is the thickness of the birefringent plate lens, and f is the focal length of the lens component.

As mentioned above, the compensation offset angle α may be determined by the maximum value θₘ of the transmission and reception offset angle to be compensated. The maximum value θₘ is associated to the scanning angular velocity ω of the scanning component in the FMCW LiDAR system and the farthest detection distance Lₘ of the FMCW LiDAR system. After the compensation offset angle α is determined, the specification of the birefringent flat lens 53 may be selected based on equations (5) and (6).

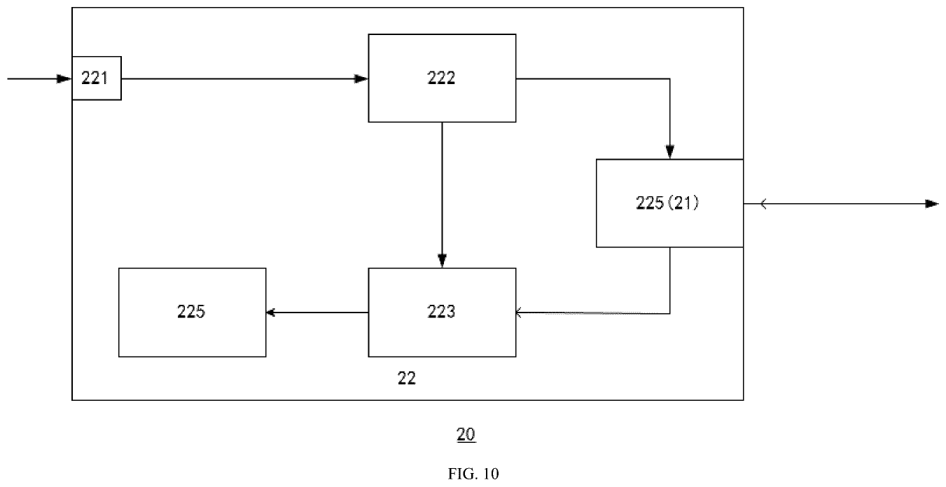

FIG. 10 is a schematic structural diagram of an optical engine provided in some embodiments of the present disclosure. As shown in FIG. 10, the optical engine 20 includes a LiDAR chip 22, which includes a frequency-swept laser beam receiving port 221, a beam splitter 222, a mixer 223, and a balanced detector 224. The use of LiDAR chips can miniaturize the overall structure of the FMCW LiDAR system.

The frequency-swept laser beam receiving port 221 is configured to receive the frequency-swept laser beam emitted by the laser source 10, which introduces the frequency-swept laser beam, such as a polarized beam in TE mode, into the LiDAR chip 22.

The beam splitter 222 is connected to the laser receiving port 221 and configured to split the frequency-swept laser beam into a detection beam and a local oscillator beam. For example, the beam splitter 222 is a 1×2 beam splitter, which splits a detection frequency-swept laser beam into two identical laser beams, that is, the wavelength, the phase, and the frequency modulation of the local oscillator beam are exactly the same as the wavelength, the phase, and the frequency modulation of the detection beam.

The mixer 223 is connected to the beam splitter 222 and configured to receive the local oscillator laser from the beam splitter 222. The mixer 223 is further configured to receive the local oscillator beam and the reflected beam, and mix the local oscillator beam and the reflected beam to obtain a frequency-mixed laser, that is, a detection beat frequency beam.

The balanced detector 224 is connected to the mixer 223, and configured to receive the frequency-mixed laser from the mixer 223, and output a detection electrical signal based on the frequency-mixed laser. The FMCW LiDAR system 100 determines a distance to an obstacle based on the detection light signal.

In some embodiments, as shown in FIG. 10, the LiDAR chip 22 further includes a polarization splitter-rotator 225. The polarization splitter-rotator 225 is used as the optical transmitter/receiver, and configured to receive the detection beam and transmit the detection beam, receive the reflected beam and change a polarization direction of the reflected beam. The polarization splitter-rotator 225 is served as the optical transmitter/receiver, and is integrated to the LiDAR chip 22, which can further reduce the size of the optical engine 20, thereby reducing the size of the FMCW LiDAR system.

Specifically, the polarization splitter-rotator 225 is connected to the beam splitter 222, and is configured to receive the detection beam outputted by the beam splitter 222, such as a polarized beam in TE mode. The detection beam is transmitted through a transceiver port of the polarization splitter-rotator 225. At this time, the polarized beam in TE mode is outputted out of the LiDAR chip 22 and propagates in space, for example, passing through the lens module 30, the birefringent component 50, and the scanning component 40, and reaching the obstacle T. The detection beam in TE mode is reflected on the surface of obstacle T, to form a reflected beam, such as a polarized beam in TM mode. The reflected beam is coupled into the transceiver port of the polarization splitter-rotator 225. After the reflected beam passes through polarization splitter-rotator 225, a polarized beam in TM mode is formed, which is inputted to mixer 223. The mixer 223 is configured to receive a local oscillator beam from the beam splitter 222, such as a polarized beam in TE mode, and the reflected beam from the polarization splitter-rotator.

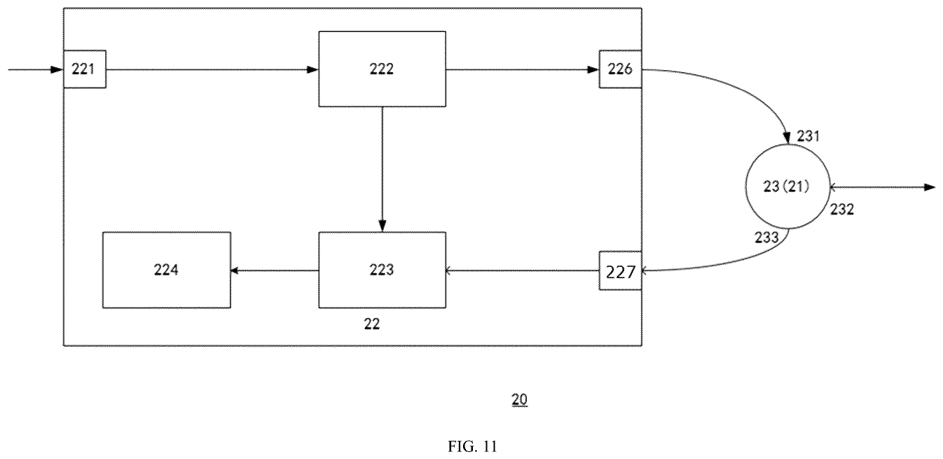

FIG. 11 is a schematic structural diagram of an optical engine provided in some embodiments of the present disclosure. In some embodiments, as shown in FIG. 11, compared with the embodiment of FIG. 10, the LiDAR chip 22 includes the frequency-swept laser beam receiving port 221, the beam splitter 222, the mixer 223, and the balance detector 224, but does not include the polarization splitter-rotator 225.

The LiDAR chip 22 further includes a detection beam transmitting port 226 and a reflected beam receiving port 227. The detection beam transmitting port 226 is connected to the beam splitter 222 and configured to receive the detection beam from the beam splitter 222 and transmit the detection beam. The reflected beam receiving port 227 is configured to receive the reflected beam. The reflected beam receiving port 227 is connected to the mixer 223 and configured to transmit the reflected beam as received to the mixer 223.

For example, the optical transmitter/receiver 21 includes a circulator 23. The circulator includes a first port 231, a second port 232, and a third port 233. The first port 231 is connected to the detection beam transmitting port 226 of the LiDAR chip 22, and is configured to receive the detection beam transmitted by the detection beam transmitting port 226 and transmit the detection beam to the second port 232. The second port 232 of the circulator 23 is taken as the transceiver port 211 of the optical transmitter/receiver 21 for transmitting a detection beam and receiving a reflected beam in a coaxial manner. Specifically, after the detection beam is transmitted from the second port, the detection beam propagates in space, for example, passing through the lens module 30, the birefringent component 50, and the scanning component 40, and reaches the obstacle T to form a reflected beam. The reflected beam passes through the scanning component 40, the birefringent component 50, and the lens module 30, then the reflected beam is coupled into the second port 232 of the circulator 23. The reflected beam coupled into the circulator 23 through the second port 232 can only be transmitted to the third port 233 of the circulator 23. In addition to transmitting the detection beam, the second port also receives the reflected beam and transmits the reflected beam to the third port 233. The third port 233 is connected to the reflected beam receiving port 227 of the LiDAR chip 22, and transmits the reflected beam to the reflected beam receiving port 227.

In some embodiments, the FMCW LiDAR system further includes an obtaining and processing device, not shown in the drawings. The obtaining and processing device is electrically connected to the balance detector 224, and is configured to receive a detection electrical signal from the balance detector 224, and process the detection electrical signal to determine a distance and/or a velocity of the obstacle. In some embodiments, the obtaining and processing device includes an analog-to-digital conversion module and a signal processing module. The analog-to-digital conversion module, such as an analog-to-digital converter, receives a detection electrical signal from the balance detector 224, which is an analog signal. The analog-to-digital conversion module converts the detection electrical signal, which is an analog signal, into a digital signal. The signal processing module is connected to the analog-to-digital conversion module, and is configured to receive the digital signal from the analog-to-digital conversion module, and process the digital signal to determine a distance and/or a velocity of the detected target object. In some embodiments, the signal processing module may be a field programmable gate array (FPGA), digital signal processing (DSP), or the like.

The aforementioned embodiments are described by taking a laser transmission channel as an example, a birefringent component is added to compensate for a transmission and reception offset angle caused by rotation of a scanning component, a detection beam and a reflected beam in the laser transmission channel of the FMCW LiDAR system can be transmitted and received through a same port, thereby ensuring detection performance of the FMCW LiDAR system while minimizing the size of the FMCW LiDAR system. It can be appreciated by those skilled in the art that the FMCW LiDAR system may include two or more laser transmission channels, and a detection beam and a reflected beam transmitted in each laser transmission channel can be transmitted and received through a same port. Multiple laser transmission channels may share a lens component, a scanning component, and a birefringent component.

The present disclosure provides a mobile device, which includes the FMCW LiDAR system as described in the aforementioned embodiments. The mobile device may be a vehicle, such as unmanned cleaning vehicle, unmanned logistics vehicle, pilotless automobile, etc.

Various parts of this specification are described in a combination of parallel and progressive manner, each part emphasizes its differences from other parts, and the same and similar parts between multiple parts can be referred to each other.

Based on the above description of the embodiments of the present disclosure, features recorded in various embodiments in this specification can be replaced or combined with each other, to enable person of ordinary skill in the art to implement or use this application. Various modifications to these embodiments will be apparent to person of ordinary skill in the art, and general principles defined herein can be implemented in other embodiments without departing from the spirit or scope of this application. Therefore, this application will not be limited to the embodiments shown in this specification, but will conform to the broadest scope consistent with the principles and novel features disclosed in this specification.

Finally, it should be noted that each embodiment in this specification is described by way of example, and each embodiment focuses on its differences from other embodiments. The same and similar parts between multiple embodiments can be referred to each other. For the system or device disclosed in the embodiments, the description is relatively simple as it corresponds to the method disclosed in the embodiments. For relevant information, reference may be made to the description in the method embodiments.

The above embodiments are only used to illustrate the technical solution of the present disclosure, but not to limit it. Although the present disclosure has been described in detail with reference to the aforementioned embodiments, those skilled in the art should appreciate that the technical solution described in the aforementioned embodiments can still be modified, or some of the technical features can be equivalently substituted. These modifications or substitutions will not make the essence of the corresponding technical solution depart from the spirit and scope of the technical solutions of multiple embodiments of the present disclosure.

What is claimed is:

1. A Frequency-Modulated Continuous Wave (FMCW) light detection and ranging (LiDAR) system, comprising:
a laser source, configured to emit a frequency-swept laser beam;
a light engine, comprising an optical transmitter/receiver, wherein the light engine is configured to receive the frequency-swept laser beam, and transmit, as a detection beam, at least a part of the frequency-swept laser beam from the optical transmitter/receiver, and the optical transmitter/receiver is further configured to receive a reflected beam formed after the detection beam is incident on an obstacle;
a scanning component, arranged on one side of the optical transmitter/receiver and configured to deflect the detection beam to perform scanning on the detection beam; and
a birefringent component, configured to compensate for a transmission and reception offset angle caused by motion of the scanning component, to enable the detection beam and the reflected beam to be transmitted and received by a same port of the optical transmitter/receiver.

2. The FMCW LiDAR system according to claim 1, further comprising:
a lens component, arranged between the optical transmitter/receiver and the scanning component, and configured to collimate the detection beam and couple the reflected beam into the optical transmitter/receiver,
wherein the detection beam is a beam in a first polarization mode with a first polarization direction, the reflected beam is a beam in a second polarization mode with a second polarization direction, the first polarization direction is perpendicular to the second polarization direction, and the beam in the first polarization mode and the beam in the second polarization mode have different refractive indices in the birefringent component.

3. The FMCW LiDAR system according to claim 2, wherein the birefringent component is configured with a compensation offset angle α for the reflected beam, and the compensation offset angle α is determined by the following formula:
$$0 < α \leq θ m$$
where θₘ is a maximum value of the transmission and reception offset angle, and θₘ is determined by the following formula:
$${θ}_{m} = ω \times Δ t = ω \times \frac{2 {L}_{m}}{c}$$
where ω is a scanning angular velocity of the scanning component, Lₘ is a maximum detection distance of the FMCW LiDAR system, and c is the speed of light.

4. The FMCW LiDAR system according to claim 3, wherein the birefringent component comprises an optical wedge, the optical wedge is located between the lens component and the scanning component, an inclined surface of the optical wedge is farther from the lens component than a plane surface of the optical wedge, an optical axis of the optical wedge is perpendicular to an optical axis of the lens component, and the compensation offset angle α satisfies the following formula:
$$α = arctan ( {n}_{2} sin β ) - arcta n ( {n}_{1} sin β )$$
where n₁ is a refractive index of the beam in the first polarization mode in the optical wedge, n₂ is a refractive index of the beam in the second polarization mode in the optical wedge, and β is a wedge angle of the optical wedge.

5. The FMCW LiDAR system according to claim 3, wherein the birefringent component comprises a polarization beam-splitter prism group, the polarization beam-splitter prism group is arranged between the lens component and the scanning component, the polarization beam-splitter prism group comprises a first right-angle prism and a second right-angle prism having inclined surfaces bonded together, an optical axis of the first right-angle prism is parallel to an optical axis of the lens component, the second right-angle prism is arranged on a side of the first right-angle prism away from the lens component, an optical axis of the second right-angle prism is perpendicular to the optical axis of the lens component, and the compensation offset angle α satisfies the following formula:
$$α = arctan ( 0.7 {n}_{4} ) - arcta n ( 0.7 {n}_{3} )$$
where n₃ is a refractive index of the beam in the first polarization mode in the polarization beam-splitter prism group, and n₄ is a refractive index of the beam in the second polarization mode in the polarization beam-splitter prism group.

6. The FMCW LiDAR system according to claim 3, wherein the birefringent component comprises a birefringent flat lens, the birefringent flat lens is arranged between the lens component and the optical transmitter/receiver, the birefringent flat lens is arranged parallel to the lens component, an optical axis of the birefringent flat lens intersects with an optical axis of the lens component, and the compensation offset angle α satisfies the following formula:
$$α = arctan ( \frac{d}{f} )$$
$$d = D \cdot ( 1 - \frac{{n}_{5}^{2}}{{n}_{6}^{2}} ) \cdot \frac{tan ( γ )}{1 + \frac{{n}_{5}^{2}}{{n}_{6}^{2}} \cdot {tan}^{2} ( γ )}$$
where n₃ is a refractive index of the beam in the first polarization mode in the birefringent plate lens, n₃ is the refractive index of the beam in the second polarization mode in the birefringent plate lens, γ is an angle between the optical axis and a plane surface of the birefringent plate lens, d is a thickness of the birefringent plate lens, and f is a focal length of the lens component.

7. The FMCW LiDAR system according to claim 1, wherein the light engine comprises a LiDAR chip, and the LiDAR chip comprises:
a frequency-swept laser beam receiving port, configured to receive the frequency-swept laser beam;
a beam splitter, connected to the frequency-swept laser beam receiving port, and configured to split the frequency-swept laser beam into the detection beam and a local oscillator beam;
a mixer, configured to receive the local oscillator beam and the reflected beam, and mix the local oscillator beam and the reflected beam to obtain a frequency-mixed laser; and
a balanced detector, configured to receive the frequency-mixed laser and output a detection electrical signal based on the frequency-mixed laser,
wherein the FMCW LiDAR system further comprises: an obtaining and processing device, electrically connected to the balance detector, and configured to receive the detection electrical signal from the balance detector, and process the detection electrical signal to determine a distance of the obstacle relative to the FMCW LiDAR system and/or a velocity of the obstacle.

8. The FMCW LiDAR system according to claim 7, wherein the LiDAR chip further comprises:
a polarization splitter-rotator, used as the optical transmitter/receiver, and configured to receive the detection beam and transmit the detection beam, receive the reflected beam and change a polarization direction of the reflected beam,
the mixer is configured to receive the local oscillator beam from the beam splitter and the reflected beam from the polarization splitter-rotator.

9. The FMCW LiDAR system according to claim 7, wherein the LiDAR chip further comprises:
a detection beam transmitting port, configured to receive the detection beam from the beam splitter and transmit the detection beam; and
a reflected beam receiving port, configured to receive the reflected beam,
the optical transmitter/receiver comprises a circulator, the circulator comprises a first port, a second port, and a third port, wherein the first port is connected to the detection beam transmitting port, and is configured to receive the detection beam transmitted by the detection beam transmitting port, and transmit the detection beam to the second port, where the detection beam is transmitted out from the second port,
the second port is further configured to receive the reflected beam and transmit the reflected beam to the third port, and the third port is connected to the reflected beam receiving port, and is configured to transmit the reflected beam to the reflected beam receiving port.

10. A mobile device, comprising:
a Frequency-Modulated Continuous Wave (FMCW) light detection and ranging (LiDAR) system, wherein, the FMCW LiDAR system comprises:
a laser source, configured to emit a frequency-swept laser beam;
a light engine, comprising an optical transmitter/receiver, wherein the light engine is configured to receive the frequency-swept laser beam, and transmit, as a detection beam, at least a part of the frequency-swept laser beam from the optical transmitter/receiver, and the optical transmitter/receiver is further configured to receive a reflected beam formed after the detection beam is incident on an obstacle;
a scanning component, arranged on one side of the optical transmitter/receiver and configured to deflect the detection beam to perform scanning on the detection beam; and
a birefringent component, configured to compensate for a transmission and reception offset angle caused by motion of the scanning component, to enable the detection beam and the reflected beam to be transmitted and received by a same port of the optical transmitter/receiver.

11. The mobile device according to claim 10, wherein the FMCW LiDAR system further comprises:
a lens component, arranged between the optical transmitter/receiver and the scanning component, and configured to collimate the detection beam and couple the reflected beam into the optical transmitter/receiver,
wherein the detection beam is a beam in a first polarization mode with a first polarization direction, the reflected beam is a beam in a second polarization mode with a second polarization direction, the first polarization direction is perpendicular to the second polarization direction, and the beam in the first polarization mode and the beam in the second polarization mode have different refractive indices in the birefringent component.

12. The mobile device according to claim 11, wherein the birefringent component is configured with a compensation offset angle α for the reflected beam, and the compensation offset angle α is determined by the following formula:
$$0 < α \leq θ m$$
where θₘ is a maximum value of the transmission and reception offset angle, and θₘ is determined by the following formula:
$${θ}_{m} = ω \times Δ t = ω \times \frac{2 {L}_{m}}{c}$$
where ω is a scanning angular velocity of the scanning component, Lₘ is a maximum detection distance of the FMCW LiDAR system, and c is the speed of light.

13. The mobile device according to claim 12, wherein the birefringent component comprises an optical wedge, the optical wedge is located between the lens component and the scanning component, an inclined surface of the optical wedge is farther from the lens component than a plane surface of the optical wedge, an optical axis of the optical wedge is perpendicular to an optical axis of the lens component, and the compensation offset angle α satisfies the following formula:
α=arctan(n₂ sin β)−arctan(n₁ sin β)
where n₁ is a refractive index of the beam in the first polarization mode in the optical wedge, n₂ is a refractive index of the beam in the second polarization mode in the optical wedge, and β is a wedge angle of the optical wedge.

14. The mobile device according to claim 12, wherein the birefringent component comprises a polarization beam-splitter prism group, the polarization beam-splitter prism group is arranged between the lens component and the scanning component, the polarization beam-splitter prism group comprises a first right-angle prism and a second right-angle prism having inclined surfaces bonded together, an optical axis of the first right-angle prism is parallel to an optical axis of the lens component, the second right-angle prism is arranged on a side of the first right-angle prism away from the lens component, an optical axis of the second right-angle prism is perpendicular to the optical axis of the lens component, and the compensation offset angle α satisfies the following formula:
$$α = arctan ( 0.7 {n}_{4} ) - arcta n ( 0.7 {n}_{3} )$$
where n₃ is a refractive index of the beam in the first polarization mode in the polarization beam-splitter prism group, and n₄ is a refractive index of the beam in the second polarization mode in the polarization beam-splitter prism group.

15. The mobile device according to claim 12, wherein the birefringent component comprises a birefringent flat lens, the birefringent flat lens is arranged between the lens component and the optical transmitter/receiver, the birefringent flat lens is arranged parallel to the lens component, an optical axis of the birefringent flat lens intersects with an optical axis of the lens component, and the compensation offset angle α satisfies the following formula:
$$α = arctan ( \frac{d}{f} )$$
$$d = D \cdot ( 1 - \frac{{n}_{5}^{2}}{{n}_{6}^{2}} ) \cdot \frac{tan ( γ )}{1 + \frac{{n}_{5}^{2}}{{n}_{6}^{2}} \cdot {tan}^{2} ( γ )}$$
where n₃ is a refractive index of the beam in the first polarization mode in the birefringent plate lens, ne is the refractive index of the beam in the second polarization mode in the birefringent plate lens, γ is an angle between the optical axis and a plane surface of the birefringent plate lens, d is a thickness of the birefringent plate lens, and f is a focal length of the lens component.

16. The mobile device according to claim 10, wherein the light engine comprises a LiDAR chip, and the LiDAR chip comprises:
a frequency-swept laser beam receiving port, configured to receive the frequency-swept laser beam;
a beam splitter, connected to the frequency-swept laser beam receiving port, and configured to split the frequency-swept laser beam into the detection beam and a local oscillator beam;
a mixer, configured to receive the local oscillator beam and the reflected beam, and mix the local oscillator beam and the reflected beam to obtain a frequency-mixed laser; and
a balanced detector, configured to receive the frequency-mixed laser and output a detection electrical signal based on the frequency-mixed laser,
wherein the FMCW LiDAR system further comprises: an obtaining and processing device, electrically connected to the balance detector, and configured to receive the detection electrical signal from the balance detector, and process the detection electrical signal to determine a distance of the obstacle relative to the FMCW LiDAR system and/or a velocity of the obstacle.

17. The mobile device according to claim 16, wherein the LiDAR chip further comprises:
a polarization splitter-rotator, used as the optical transmitter/receiver, and configured to receive the detection beam and transmit the detection beam, receive the reflected beam and change a polarization direction of the reflected beam,
the mixer is configured to receive the local oscillator beam from the beam splitter and the reflected beam from the polarization splitter-rotator.

18. The mobile device according to claim 16, wherein the LiDAR chip further comprises:
a detection beam transmitting port, configured to receive the detection beam from the beam splitter and transmit the detection beam; and
a reflected beam receiving port, configured to receive the reflected beam,
the optical transmitter/receiver comprises a circulator, the circulator comprises a first port, a second port, and a third port, wherein the first port is connected to the detection beam transmitting port, and is configured to receive the detection beam transmitted by the detection beam transmitting port, and transmit the detection beam to the second port, where the detection beam is transmitted out from the second port,
the second port is further configured to receive the reflected beam and transmit the reflected beam to the third port, and the third port is connected to the reflected beam receiving port, and is configured to transmit the reflected beam to the reflected beam receiving port.
